(19) United States
(12) Patent Application Publication
(10) Pub. No.: US 2013/0136290 A1
(43) Pub. Date: May 30, 2013

(54) EARPHONE WITH TUNABLE LOW PITCH

(71) Applicant: Rextec Interanational Ltd., Zhubei City (TW)

(72) Inventor: Cheng-Houng Huang, Zhubei City (TW)

(73) Assignee: REXTEC INTERNATIONAL LTD., Zhubei City (TW)

(21) Appl. No.: 13/669,624

(22) Filed: Nov. 6, 2012

(30) Foreign Application Priority Data
Nov. 25, 2011 (TW) 100222400
Mar. 30, 2012 (TW) 101111383

(51) Int. Cl. H04R 1/20; H04R 1/02; H04R 1/10

(52) U.S. Cl. 381/345

(57) ABSTRACT

An earphone with tunable low pitch comprises a main member and a stirring member, wherein the main member has a chamber inside receiving a loud speaker, a low pitch room formed between the main member and the loud speaker, at least a fixing air hole provided at the rear side of the main member, a high pitch room formed between the front side of the main member and the loud speaker, at least a regulative air hole is provided at the high pitch room; the stirring member, which is pivotally joined to the pivot hole, is designed as a disk to close the regulative air hole or as airflow baffles to close corresponding airflow passages gradually such that the regulative air hole or the airflow passages can be partly or fully blocked by the stirring member to change the speed of the air entering or leaving the high pitch room and result in good low frequency resonant effect.

### BACKGROUND OF THE INVENTION

1. Field of the Invention

The present invention relates to an earphone with tunable low pitch, and, more particularly, to an earphone which has a high pitch room provided with a stirring member to regulate sound output so as to produce good effect of low frequency resonance.

2.Description of Related Art

The plug type earphone is small in size and can be inserted into ears for the user listening to the electronic sound without disturbing others; the lightness and smallness of the earphone make it easy to be carried such that the earphone has become one of the essential accessories of electronic products such as the MP3 walkman, the cell phone, the personal digital assistant (PDA) or the lap top computer.

It is known that the structures and sizes of our ear canals are different from each other, our preferences to music are different from each other as well. The traditional earphone usually consists a casing, a load speaker, and signal transmission lines; although there are through holes provided at the casing near the load speaker, the through holes are employed to vibrate the load speaker back and forth normally for generating sound only; the remainder parts of the earphone are structurally sealed to limit sound release in the sealed space inside the casing such that property of sound outputting from the earphone is influenced accordingly to be such as high pitch or low pitch invariably.

As a result, the only way can be done by the user is to accept the sound effect offered by the traditional earphone; however, the user is unable to adjust the emitted sound as desired to satisfy his/her need.

Currently, although there are advanced earphones with devices for adjusting sound effects, the integral structures thereof still have deficiencies; the structural arrangements of some of the advanced earphones are excessively simple such that the adjusted sound outputs of the earphones become inferior after assembling, and other advanced earphones provide excessively complicated structural arrangements such that it become tedious and unfavorable for fabrication.

### SUMMARY OF THE INVENTION

The main objective of the present invention is to provide an earphone with tunable low pitch in which a stirring member is operated to control the regulative air hole to be partly opened, fully opened or fully blocked so as to change speeds of the airflow entering and leaving a hollow sound room therein such that a good effect of the low frequency resonance can be achieved.

To obtain the objective, the earphone with tunable low pitch according the present invention comprises a main member and a stirring member, wherein the main member has a chamber inside receiving a loud speaker, a low pitch room formed between the main member and the loud speaker, a high pitch room formed between the front side of the main member and the loud speaker; the stirring member, which is pivotally joined to the member, is designed as a disk to close the regulative air hole such that the regulative air hole can be partly or fully blocked by the stirring member to change the speed of the air entering or leaving the high pitch room and obtain good effect of low frequency resonance.

### BRIEF DESCRIPTION OF THE DRAWINGS

Further benefits and advantages of the present invention will become apparent after a careful reading of the detailed description with appropriate reference to the accompanying drawings.

FIG. 1 is a perspective view of the first preferred embodiment of an earphone with tunable pitch of according to the present invention;

FIG. 2 is a top view of an earphone with tunable pitch of the first preferred embodiment according to the present invention;

FIG. 3 is a front view of the first preferred embodiment of an earphone with tunable pitch according to the present invention;

FIG. 4 is a sectional view of the first preferred embodiment of an earphone with tunable pitch according to the present invention;

FIG. 5 is a perspective view of the first preferred embodiment of an earphone with tunable pitch according to the present invention similar to FIG. 1 for illustrating the operation thereof;

FIG. 6 is a graph illustrating frequency response of an earphone with tunable pitch of the first preferred embodiment according to the present invention;

FIG. 7 is a perspective view of the second preferred embodiment of an earphone with tunable pitch of according to the present invention;

FIG. 8 is a partially disassembled perspective view of the second preferred embodiment of an earphone with tunable pitch of according to the present invention;

FIG. 9 is a perspective view the first preferred embodiment of an earphone with tunable pitch of according to the present invention for illustrating the operation thereof;

FIG. 10 is a partial sectional view of the second preferred embodiment of an earphone with tunable pitch of according to the present invention in a state of being opened;

FIG. 11 is a partial sectional view of the second preferred embodiment of an earphone with tunable pitch of according to the present invention in a state of being closed;

FIG. 12 is a perspective view of the third preferred embodiment of an earphone with tunable pitch of according to the present invention;

FIG. 13 is a front view of the third preferred embodiment of an earphone with tunable pitch according to the present invention.

### DETAILED DESCRIPTION OF THE INVENTION

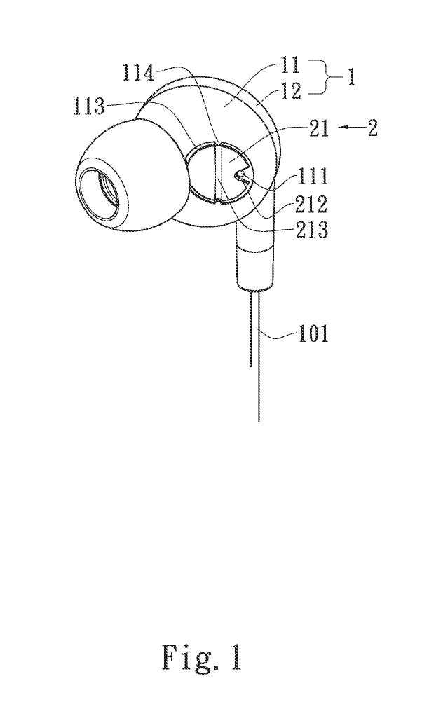

Referring to FIGS. 1 to 4, the first preferred embodiment of an earphone with tunable low pitch in accordance with the present invention comprises: a main member 1 with a chamber 10 inside to receive a loud speaker 100;

a low pitch room 10a is formed between the main member 1 and the loud speaker 100, and a high pitch room 10b is formed between the front side of the main member 1 and the loud speaker 100; transmission lines 101 externally connect with the loud speaker 100; the main member 1 consists of a front casing part 11 with a regulative air hole 111 thereon, a rear casing part 12 with a plurality of fixing air holes 121 thereon, and a sound guiding passage 102 communicating with the high pitch room 10;

a stirring member 2 which has a turning disk 21 and a pivot 211 and is located on top of the high pitch room 10, wherein the pivot 211 is disposed at the rear side of the turning disk 21 and provided with a fitting head to engage with the inner wall surface of the main member 1, and the turning disk 21 is provided with a triangular recess 212 at the circumferential side thereof corresponding to the regulative air hole 111.

Preferably, the turning disk 21 is arranged to have a through groove 213 across the turning disk 21 perpendicular to the altitude of the triangular recess 212. A circular nest 113 with a pivot hole 112 is provided at the middle of the front casing part 11 to accommodate the turning disk 21 and the pivot 211, and the circular nest 113 has two opposite sharp locating tips 114 at the annular side thereof.

Referring to FIG. 5 in company with FIG. 3, when the earphone of first embodiment according to the present invention is in use, the turning disk 21 can be rotated to allow the through groove 213 to align with the sharp locating tips 114 and let the triangular recess 212 corresponding to the regulative air hole 111 such that the regulative air hole 111 is in a state of opening as shown in FIG. 3 or can be rotated to allow the triangular recess 212 corresponding to one of the sharp locating tips 114 such that the regulative air hole 111 is in a state of closing as shown in FIG. 5. Due to the regulative air hole 111 being controlled to adjust the state thereof, speed of the air entering the high pitch room 101 is different from that leaving the high pitch room 101, and it results in the effect of the sound output changing accordingly.

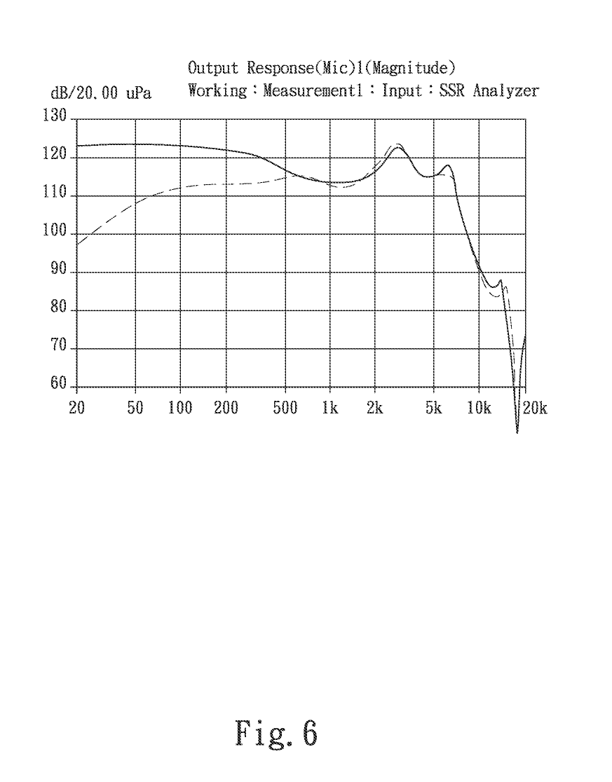

Referring to FIG. 6, a graph showing tested frequency responses is illustrated. When the turning disk 21 is operated to allow the triangular recess 212 being corresponding to the unblocked regulative air hole 111, the sound output of the earphone is indicated by dashed curves in the graph; when the turning disk 21 is operated to block the regulative air hole 111, the sound output of the earphone, which is indicated by the solid curve, is capable of obtaining a better low frequency resonant effect.

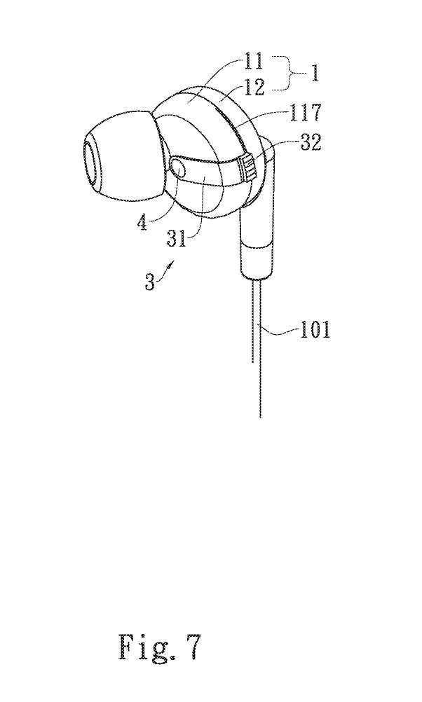

Referring to FIGS. 7 to 11, the second preferred embodiment of an earphone with tunable low pitch in accordance with the present invention comprises:

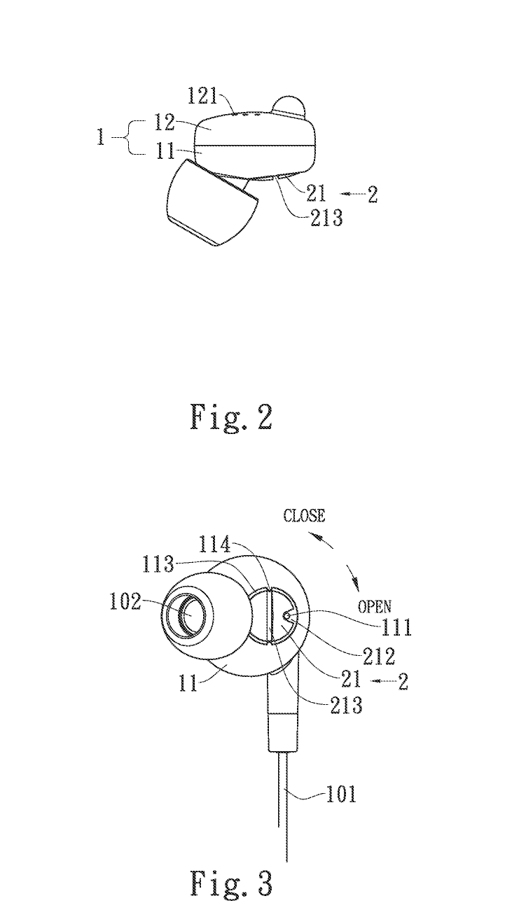

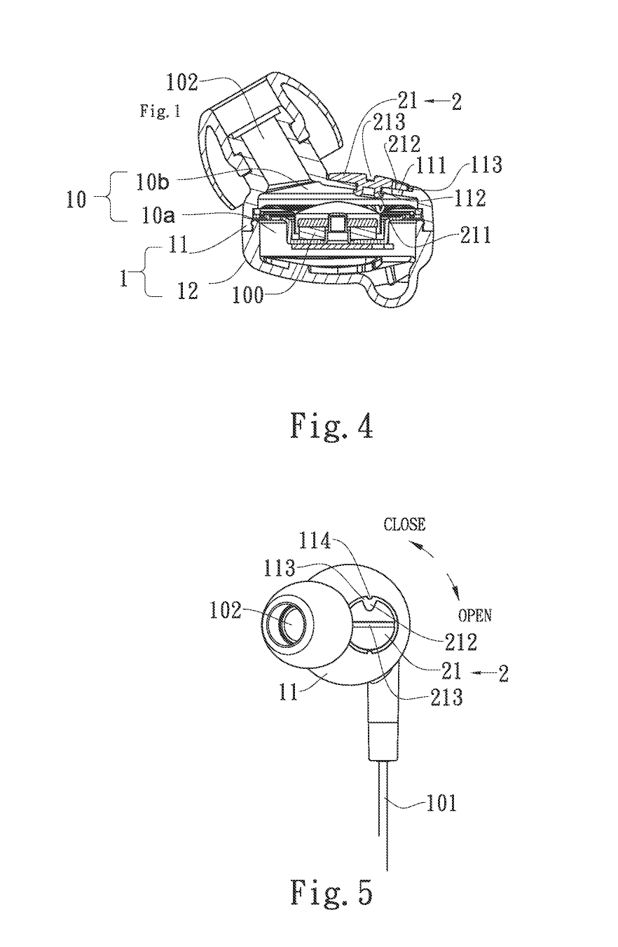

a main member 1 with a chamber 10 inside to receive a loud speaker 100 similar to that shown in FIG. 4, wherein a low pitch room 10a is formed between the main member 1 and the loud speaker 100, and a high pitch room 10b is formed between the front side of the main member 1 and the loud speaker 100; transmission lines 101 externally connect with the loud speaker 100; the main member 1 consists of a front casing part 11 with an air hole 115 disposed near the center thereof, a rear casing part 12 with a plurality of fixing air holes 121 thereon similar to those shown in FIG. 2, and a sound guiding passage 102 communicating with the high pitch room 10; a plurality of arc-shaped airflow baffles 116 are disposed to surround the air hole 115 and equally spacing apart from each other;

a stirring member 3 which is a turning lever 31 extending from the central position of the main member 1 to the bottom of the front casing part 11 along the outer surface of the main member 1, wherein an end of the turning lever 31 is an adjusting part 32 with an outer surface having fine-teeth shaped lines and a sliding rail extending inward from the bottom of the adjusting part 32 to slidably engage with a limit groove 117 formed between the front casing part 11 and the rear casing part 12, another end of the turning lever 31 provides an annular inner step 33 and a through hole 34, and a plurality of arc-shaped airflow admitting baffles 35 are disposed to surround the through hole 34 and space apart from each other;

a knob 4 which has a circular top part 41, and a diameter-reduced cylinder part 42 extending from the circular top part 41 with an enlarged lock part 43 at the end of the cylinder part 42, wherein the cylinder part 42 is provided with crossing grooves 44 to form multiple jaws and airflow passages 45.

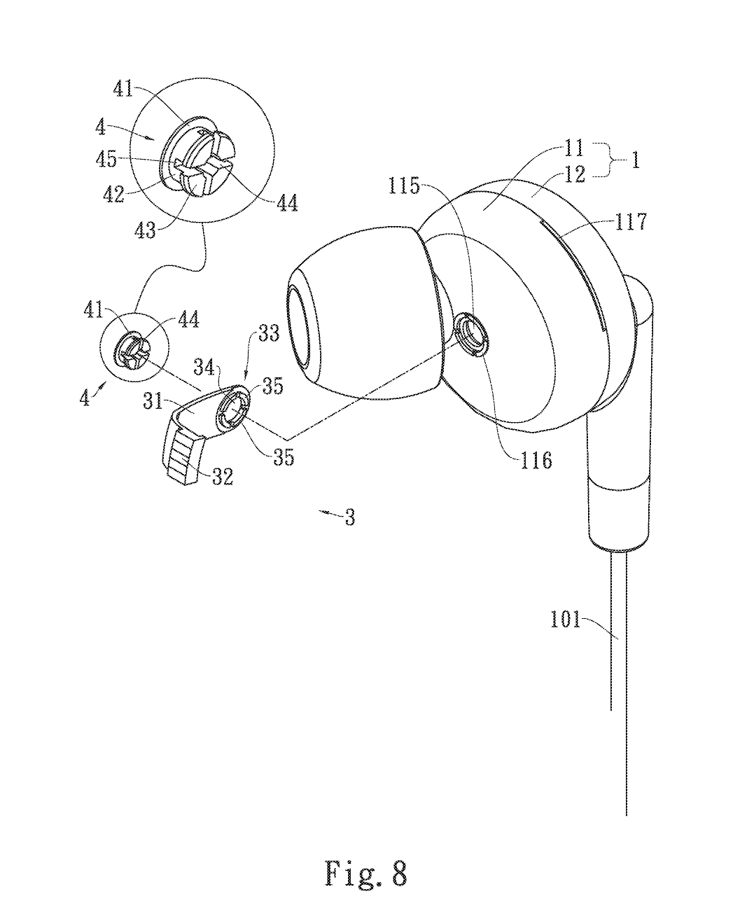

When the earphone is assembled as shown in FIGS. 8 to 10, the through hole of the turning lever 31 is aligned with the air hole 115 at center position of front casing part 11 to sleeve the arc-shaped airflow baffles 116 with the arc-shaped airflow shutting baffles 35, then the cylinder part 42 of the knob 4 is inserted to the air hole 115.

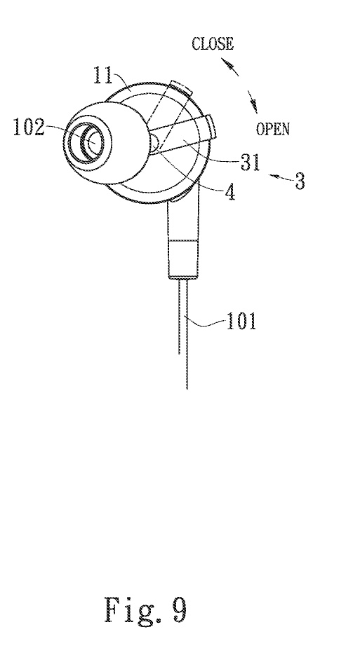

While in use, the adjusting part 32 at an end of the turning lever 31 can be stirred to change the position of the turning lever 31 based on each personal individual's need such that the arc-shaped airflow admitting baffles 35 at another end of turning lever 31 is actuated to rotate and the arc-shaped airflow baffles 116 correspondingly block the airflow passages 45 at the cylinder part 42 of the knob 4 as a rotary valve. Hence, when the turning lever 31 with sliding rail is adjustably moved in the limit groove 117 between open state and close state, the valve can be adjustably controlled to partly open, fully open or fully close so as to change the speeds of the air entering and leaving the high pitch room 10b as shown in FIG. 9. Hence, the sound output of the earphone is capable of providing effects of different low pitches.

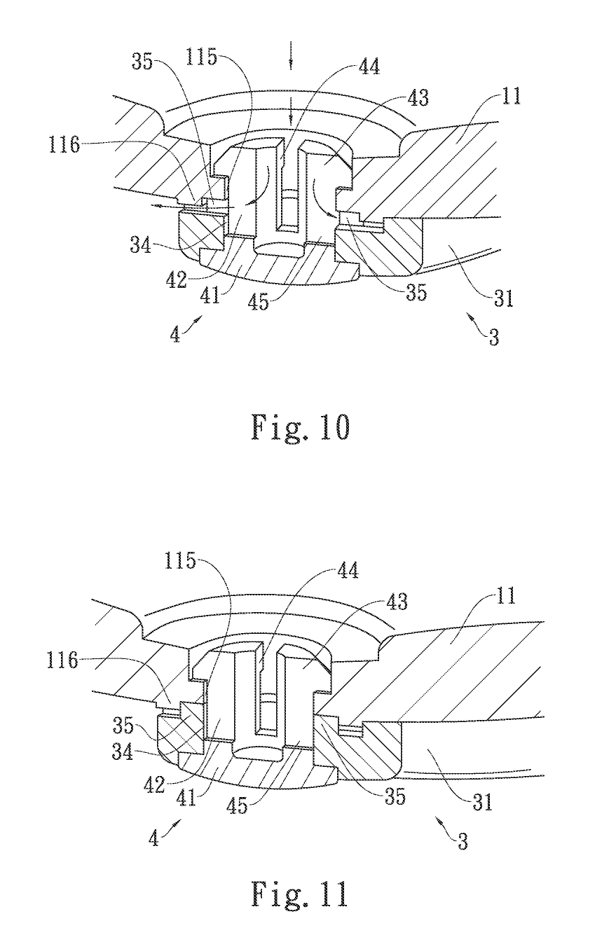

When the turning lever 31 is moved to the open state as shown in FIGS. 9 and 10, the airflow passages 45 of the cylinder part 42, the air hole 115 and the arc-shaped airflow baffles 116 of the turning lever 31 are in a state of opening respectively, the sound output of the earphone is the low frequency response and represented between the dash curve and the solid curve shown in FIG. 6. When the turning lever 31 is moved to the close state as shown in FIGS. 9 and 11, the airflow passages 45 of the cylinder part 42, the air hole 115 and the arc-shaped airflow baffles 116 of the turning lever 31 are in a state of close respectively, the sound output of the earphone is the frequency response represented by the solid curve shown in FIG. 6, and it is capable of generating the good effect of low frequency resonance.

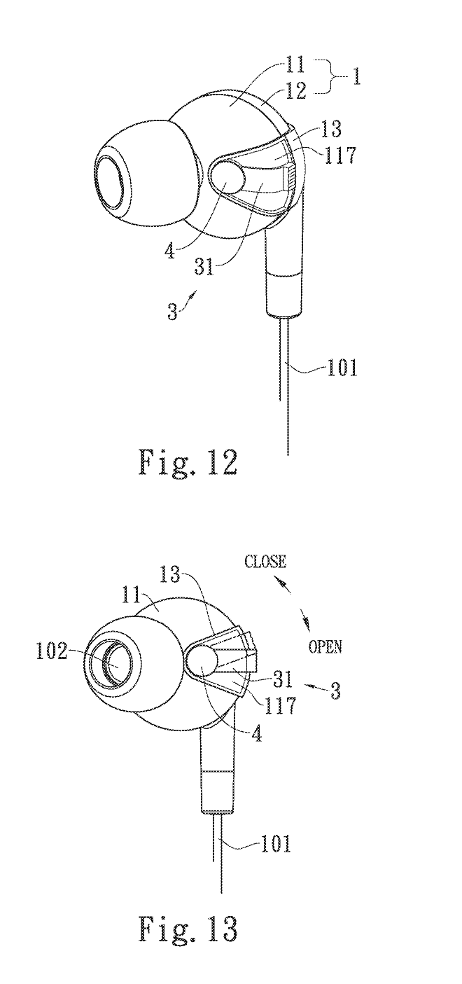

Besides, referring to FIGS. 12 and 13, the limit groove 117 can be made on a cover plate 13 to accommodate the sliding rail at the adjusting part 32, and then the cover 13 is assembled to the main member 1; in this way, the angular displacement span of the turning lever 31 can be limited as well to achieve the purpose of regulating the sound output of the earphone gradually.

Although the invention has been explained in relation to its preferred embodiments, it is to be understood that many other possible modifications and variations can be made without departing from the spirit and scope of the invention as hereinafter claimed.

What is claimed is:

1. An earphone with tunable low pitch comprising:
a main member with a chamber inside receiving a loud speaker, wherein a low pitch room is formed between the main member and the loud speaker, at least a fixing air hole is provided at the rear side of said main member, a high pitch room is formed between the front side of the main member and the loud speaker, a pivot hole is provided at the middle of the main member, at least a regulative air hole is provided at the high pitch room, and a sound guiding passage is provided to communicate with the high pitch room;
a stirring member which is pivotally joined to the pivot hole and has a recess at a lateral side thereof corresponding to the regulative air hole.

2. The earphone as defined in claim 1, wherein the loud speaker externally connects with transmission lines.

3. The earphone as defined in claim 1, wherein said main member is composed of a front casing part and a rear casing part.

4. The earphone as defined in claim 1, wherein said stirring member is a turning disk.

5. The earphone as defined in claim 1, wherein said fixing air hole is provided at the rear casing part, and the pivotal hole is provided at the front casing part.

6. The earphone as defined in claim 5, wherein said turning disk has a pivot to pivotally connect with the pivot hole.

7. The earphone as defined in claim 6, wherein the recess of the turning disk is triangular shape.

8. The earphone as defined in claim 7, wherein said front casing part has a circular nest surrounding the pivot hole to accommodate the turning disk.

9. The earphone as defined in claim 8, wherein two opposite sharp tips are provided at the annular side of the circular nest.

10. The earphone as defined in claim 8, wherein the turning disk has a through groove perpendicular to the altitude of the triangular recess.

11. An earphone with tunable low pitch comprising:
a main member with a chamber inside receiving a loud speaker, wherein a low pitch room is formed between the main member and the loud speaker, at least a fixing air hole is disposed at the rear side of main body, a high pitch room is formed between the front side of the main member and the loud speaker, a pivotal hole is disposed at the middle of the main member, and a plurality of airflow baffles surrounding the pivotal hole;
a stirring member which is disposed on the pivotal hole with an end thereof being an adjusting part and another end thereof provided with a through hole and a plurality of airflow admitting baffles surrounding the through hole and spacing apart from each other to alternately correspond to the airflow baffles disposed at the main member;
a knob which has a diameter-reduced cylinder with crossing grooves to form a plurality of jaws and air passages, wherein the cylinder has an enlarged lock part for the stirring member being capable of engaging with the main member.

12. The earphone as defined in claim 11, wherein transmission lines 101 are provided to externally connect with the loud speaker.

13. The earphone as defined in claim 11, wherein said main member is composed of a front casing part and a rear casing part.

14. The earphone as defined in claim 11, wherein said stirring member is a turning lever.

15. The earphone as defined in claim 11, wherein said adjusting part is a projection with fine-teeth-shaped lines.

16. The earphone as defined in claim 11, wherein said airflow baffles and said airflow admitting baffles are arc-shaped.

17. The earphone as defined in claim 11, wherein an inner annular step is provided next to the through hole corresponding to the airflow shutting baffles.

18. The earphone as defined in claim 17, wherein said adjusting part is provided with a projection rail at the bottom thereof slidably disposed in a limit groove provided between the front and rear casing parts.

19. The earphone as defined in claim 17, wherein said adjusting part is provided with a projection rail at the bottom thereof to be slidably disposed in a limit groove provided at a cover plate.
